(19) United States
(12) Patent Application Publication
(10) Pub. No.: US 2013/0028299 A1
(43) Pub. Date: Jan. 31, 2013

(54) ADAPTIVE ETHERNET TRANSCEIVER WITH JOINT DECISION FEEDBACK EQUALIZER AND TRELLIS DECODER

(71) Applicant: TIEN-JU TSAI, Tainan City (TW)

(72) Inventor: TIEN-JU TSAI, Tainan City (TW)

(73) Assignee: HIMAX MEDIA SOLUTIONS, INC., Tainan City (TW)

(21) Appl. No.: 13/191,286

(22) Filed: Jul. 26, 2011

(51) Int. Cl. H04L 5/16

(52) U.S. Cl. 375/219

(57) ABSTRACT

An adaptive Ethernet transceiver is disclosed. A joint decision feedback equalizer (DFE) and Trellis decoder is configured to decode a receiving signal. A decoder control unit is configured to adaptively disable a portion of the joint DFE and Trellis decoder in a non-specified link speed mode.

### CROSS-REFERENCE TO RELATED APPLICATIONS

The present invention is related to a co-pending U.S. patent application, by the same inventor of the present application and assigned to the same assignee of the present application, entitled JOINT DECISION FEEDBACK EQUALIZER AND TRELLIS DECODER (Att. Docket HI8573P), the complete subject matter of which is hereby incorporated herein by reference in its entirety.

### BACKGROUND OF THE INVENTION

1. Field of the Invention

The present invention generally relates to an Ethernet transceiver, and more particularly to an adaptive joint decision feedback equalizer and Trellis decoder adaptable to an Ethernet transceiver.

2. Description of Related Art

Ethernet standards 10BASE-T, 100BASE-TX, 1000BASE-T and higher-speed Ethernet use unshielded twisted pair (UTP) as a transmission medium. As link speed becomes higher, it becomes more difficult to design the physical layer (PHY), when considering constraints such as multipath fading, pulse/white noise, adjacent/co-channel interferences in wireless channel, or inter-symbol interference (ISI), (near-end or far-end) channel crosstalk, echo or thermal noise in wired channel. In gigabit Ethernet (1000BASE-T), Trellis-coded modulation (TCM) is used as error control coding (ECC), which may, in theory, achieve a coding gain of 5.6 dB.

Viterbi decoder is commonly used to decode TCM code. However, it is noticed that the target 5.6 dB coding gain cannot be satisfactorily achieved by the conventional transceiver, particularly the transceiver having separate Viterbi decoder and ISI post-cursor equalizer that may result in error propagation. In order to improve the coding gain and error propagation, Kamran Azadet discloses a 1-tap lookahead-parallel decision feedback decoder (LA-PDFD) in “A 1-Gb/s Joint Equalizer and Trellis Decoder for 1000BASE-T Gigabit Ethernet,” IEEE Journal of Solid-State Circuits, Vol. 36, No. 3, March 2001; and U.S. Pat. No. 7,363,576 entitled “Method and Apparatus for Pipelined Joint Equalization and Decoding for Gigabit Communications,” the disclosures of which are hereby incorporated by reference. The scheme disclosed by Azadet, however, cannot effectively improve the coding gain with respect to Ethernet having a link segment length greater than the specified 100 m. In order to resolve this problem, Lin et al. discloses a P-tap parallel decision feedback decoder (PDFD) in U.S. Pat. No. 7,188,302 entitled “Parallel Decision-Feedback Decoder and Method for Joint Equalizing and Decoding of Incoming Data Stream,” the disclosure of which is hereby incorporated by reference.

It is not uncommon that a gigabit Ethernet transceiver cannot operate at 1000M bit/sec, for example, because the communication channel does not satisfy the specified requirements such as over-length link segment or noisy channel or because the partner does not support the speed of 1000M bit/sec. In such situation, the transceiver steps down from gigabit speed to the lower speed of 100M bit/sec and a substantial portion of the transceiver that takes charge of processing gigabit transfer becomes idle, thereby wasting resource provided by the gigabit Ethernet transceiver.

For the foregoing reasons, a need has arisen to propose a novel scheme that can effectively and adaptively utilize the gigabit Ethernet transceiver.

### SUMMARY OF THE INVENTION

In view of the foregoing, it is an object of the embodiment of the present invention to provide an adaptive joint decision feedback equalizer and Trellis decoder that can be adapted to multiple link speeds to substantially improve performance of the Ethernet transceiver.

According to one embodiment, the adaptive Ethernet transceiver comprises a decoder control unit and a joint decision feedback equalizer (DFE) and Trellis decoder. The joint decision feedback equalizer (DFE) and Trellis decoder is configured to decode a receiving signal. The decoder control unit is configured to adaptively disable a portion of the joint DFE and Trellis decoder in a non-specified link speed mode. In one exemplary embodiment, the decoder control unit adaptively blocks the output of at least one canceller from entering the joint DFE and Trellis decoder in the non-specified link speed mode.

### BRIEF DESCRIPTION OF THE DRAWINGS

FIG. 1 schematically shows a communication system compliant with gigabit Ethernet over four category-5 (CAT-5) unshielded twisted pairs (UTPs);

FIG. 2 shows a block diagram of a gigabit Ethernet transceiver of FIG. 1;

FIG. 3 shows a detailed block diagram of the transmitting section of the PCS block of FIG. 2;

FIG. 4A shows a ID symbol set for a five-level pulse amplitude modulation (PAM5) constellation;

FIG. 4B shows 4D symbol subset partition;

FIG. 5 shows trellis state transition of a convolutional code;

FIG. 6 shows a block diagram of a fast Ethernet transceiver;

FIG. 7A shows a flow diagram of an MLT3 encoder;

FIG. 7B shows a 1D symbol set for a three-level MLT3 constellation;

FIG. 7C shows exemplary trellis state transition of MLT3;

FIG. 8 shows a block diagram of an adaptive gigabit Ethernet transceiver according to a first embodiment of the present invention;

FIG. 9 shows a detailed block diagram of the joint DFE & TCM decoder of FIG. 8 according to one embodiment of the present invention;

FIG. 10 shows a detailed block diagram exemplifying the 4D-BMU for calculating 4D branch metrics (4D-BMs) from state 0;

FIG. 11A shows a detailed block diagram exemplifying the ACSU for updating the path metrics for state 0 in. the gigabit mode;

FIG. 11B shows a detailed block diagram exemplifying the ACSU for updating the path metrics for state 0 in the non-gigabit mode;

FIG. 11C shows a minimum state logic of the ACSU;

FIG. 12A shows a detailed block diagram of the SMU of FIG. 9 in the gigabit mode according to one embodiment of the present invention;

FIG. 12B shows a detailed block diagram of the SMU of FIG. 9 in the non-gigabit mode according to one embodiment of the present invention;

FIG. 13 shows a detailed block diagram of the DFU of FIG. 9 according to one embodiment of the present invention;

FIG. 14 shows a flow diagram of the decoder control unit of FIG. 8 according to one embodiment of the present invention;

FIG. 15 shows a block diagram of an adaptive fast. Ethernet transceiver according to a second embodiment of the present invention; and

FIG. 16 shows a flow diagram of the decoder control unit of FIG. 15 according to one embodiment of the present invention.

### DETAILED DESCRIPTION OF THE INVENTION

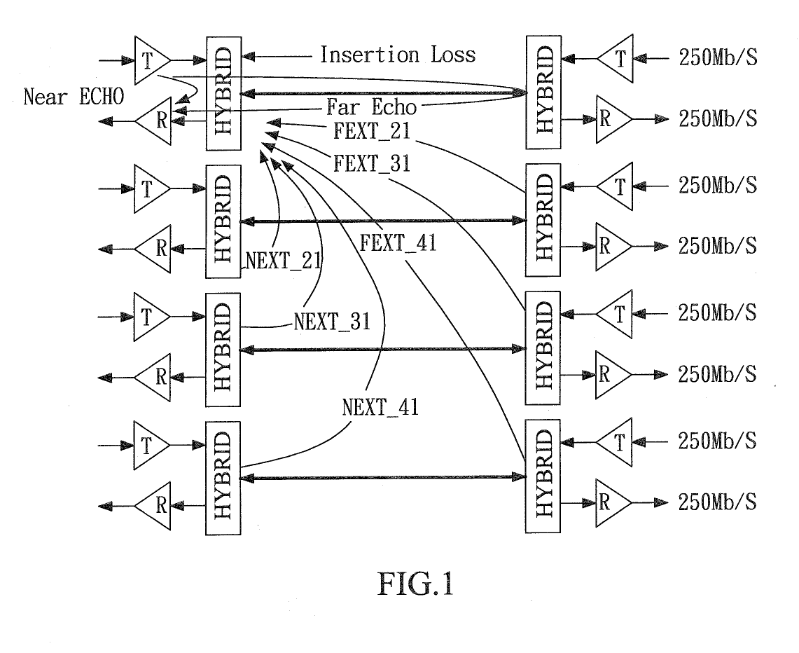

FIG. 1 schematically shows a communication, system compliant with gigabit Ethernet over four category-5 (CAT-5) unshielded twisted pairs (UTPs). Four-dimensional (4D) Trellis coded modulation (TCM) is used in gigabit Ethernet across the four pairs, each of which contributes one-dimension (1D). With respect to 100BASE-TX, two wire pairs are used one pair is dedicated exclusively for transmitting and the other pair is dedicated exclusively for receiving.

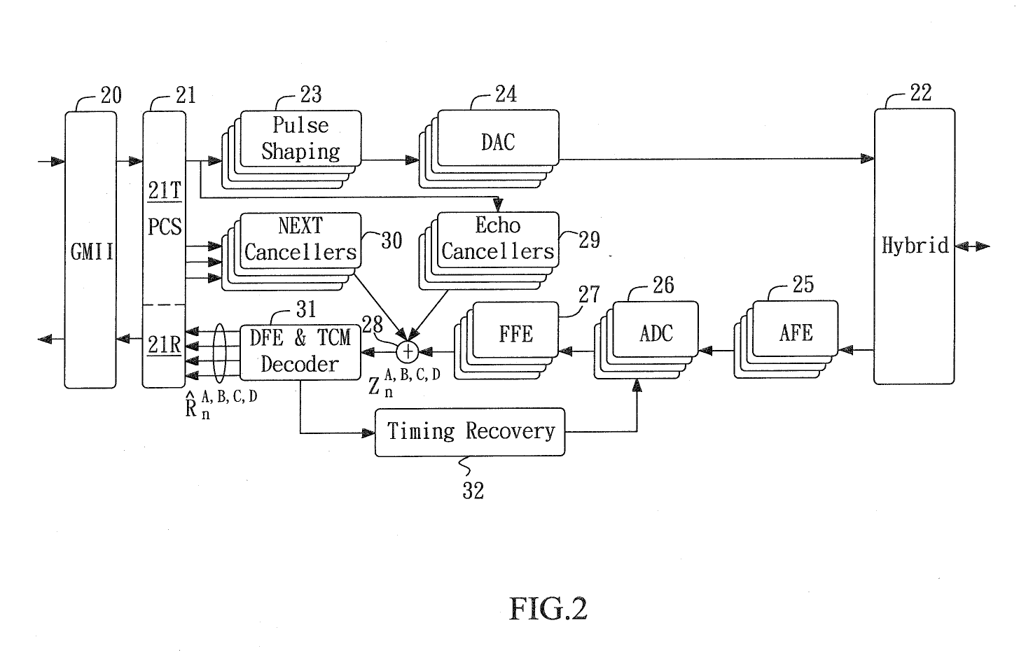

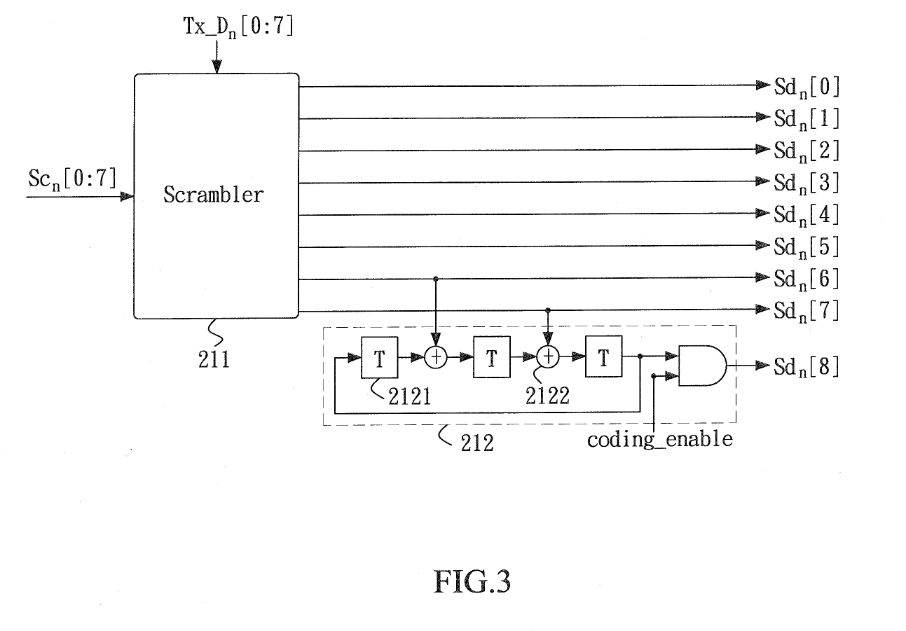

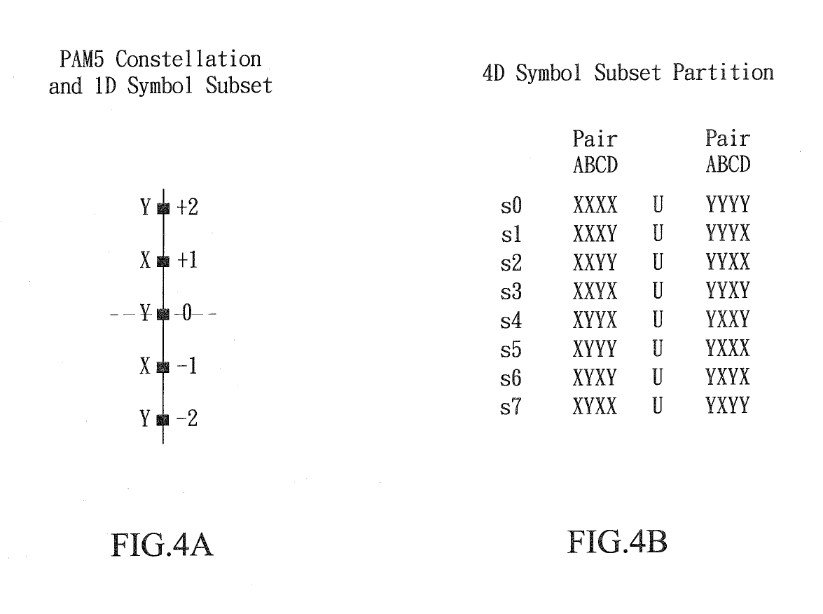

FIG. 2 shows a block diagram of a gigabit Ethernet transceiver of FIG. 1. Only blocks pertinent to the present invention are shown in the figure. On a transmitting path, a Gigabit Medium Independent Interface (GMII) block 20 receives 8-bit (transmitting) data from Media. Access Control (MAC) (not shown) and passes the 8-bit data to the transmitting section 21T of a Physical Coding Sublayer (PCS) block 21. FIG. 3 shows a detailed, block diagram of the transmitting section 21T of the PCS block 21 of FIG. 2. Specifically, the transmitting section 21T of the PCS block 21 performs scrambling on the 8-bit data Tx_Dₙ[0:7] by a scrambler 211, therefore generating 8-bit (scrambled) data Sdₙ[0:7]. The transmitting section 21T of the PCS block 21 also performs TCM coding on the 8-bit data by a convolutional encoder 212 such as a linear feedback shift register that includes three delay elements 2121 and two summing devices 2122 interspersed between the adjacent delay elements 2121. The convolutional encoder 212 receives data. Sdₙ[6:7] and accordingly generates (encoded) data Sdₙ[8]. The scrambled data Sdₙ[0:7] and the encoded data Sdₙ[8], 9-bit in total, are then mapped to 4D symbols. Each of the four dimensions corresponds to one of wire pairs. In each dimension, possible symbols are selected from a 1D symbol set (−2, −1, 0, +1, +2) as depicted in FIG. 4A, a five-level pulse amplitude modulation (PAM5) constellation. The symbol set is partitioned into two symbol subsets X and Y, for example, with X={−1, +1} and Y={−2, 0, +2}. The 1D symbol subsets are then combined to form 4D symbol subsets (or code subsets) S0 to s7, according to Trellis coding, representing the four wire pairs. As shown in FIG. 4B, each 4D symbol subset includes a union of two complementary 4D symbol subsets, e.g., XXXY and YYYX of s1.

Referring back to FIG. 2, before the symbols are transmitted to the UTPs via a hybrid block 22, the four 1D symbols are processed by pulse shaping blocks 23 (precisely speaking, partial-response filter may be adopted) respectively to reduce electromagnetic interference (EMI), followed, by being converted to analog signals by digital-to-analog converters (DACs) 24 operating at 125 MHz.

On a receiving path, the hybrid block 22 receives analog signals from four wire pairs. The received 4D signals are then preconditioned respectively by analog front-ends (AFEs) 25 such as programmable gain amplifiers (PGAs), baseline wander compensator (BWC), and programmable low-pass filter (PLPF), followed by being converted to digital signals by analog-to-digital converters (ADCs) operating at 125 MHz. The converted digital signals are processed by feed-forward equalizers (FFEs) 27 or ISI pre-cursor equalizers. Subsequently, a summing device 28 is used to subtract echo quantity of echo cancellers 29 and near-end crosstalk quantity of NEXT cancellers 30 from the output of the FIFE 27. In the specification, the output of the FIFE 27 is also called a receiving signal. The cancelled signals from the summing device 28 are processed by a joint decision feedback equalizer (DFE, or ISI post-cursor equalizer) and TCM decoder 31, thereby resulting in decoded signals \hat{R}ₙ^{A,B,C,D}, 9-bit data, which are fed to the receiving section 21R of the PCS block 21 and are then further forwarded to the GMII 20. A timing recovery block 32, which is under control of the joint DFE & TCM decoder 31, is also used to control sampling timing of the ADC 26.

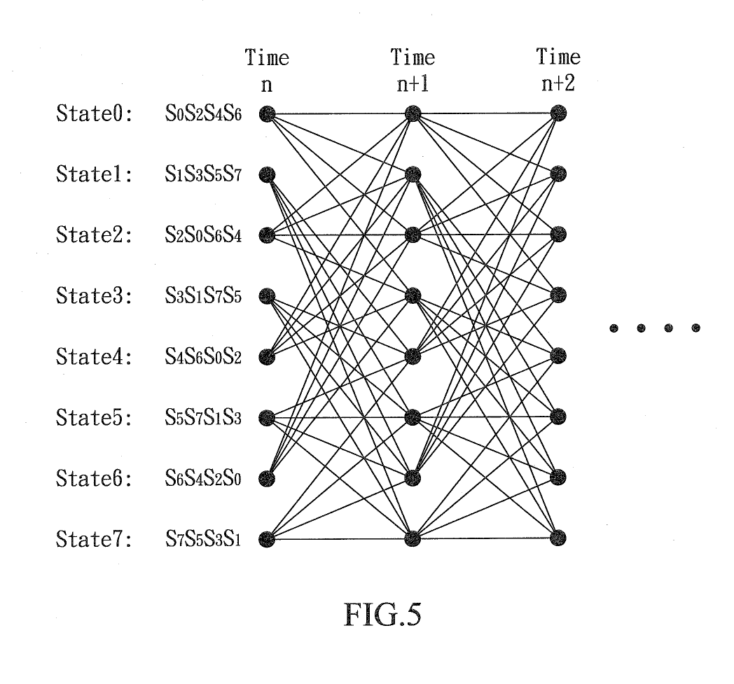

FIG. 5 shows trellis state transition of a convolutional code, i.e., Trellis code. In the trellis diagram, the nodes at the first column represent possible states (state 0 to state 7) that the convolutional encoder 212 (FIG. 3) may assume at time n. Similarly, the nodes at the second and third columns represent possible states at time n+1 and n+2 respectively. From a current state, a subsequent 4D symbol corresponds to a transition (or branch) from the current state to a permissible succeeding state. In other words, each branch may be characterized by a current state, a preceding state and a corresponding 4D symbol. Accordingly, a valid sequence of states (or a valid sequence of 4D symbols) may be represented by a path through the trellis. The trellis diagram may be adapted, at the receiver end, to decode the signals Zₙ^{A,B,C,D} (FIG. 2), by the joint DFE & TCM decoder 31, according to Viterbi algorithm. Given a sequence of received, symbols, the most likable path to every node is calculated and the distance between each path and the received sequence is determined in order to determine a path metric.

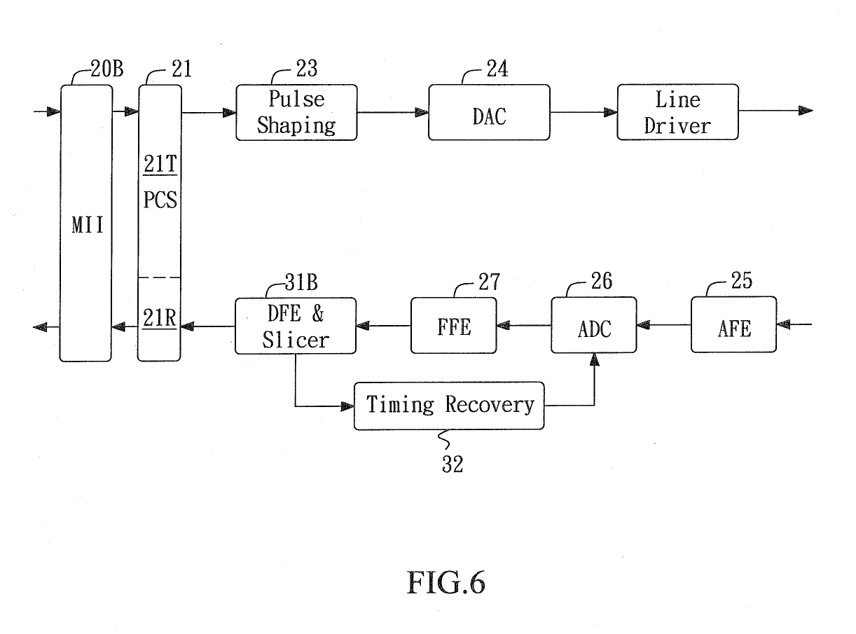

FIG. 6 shows a block diagram of a fast Ethernet (or 100BASE-TX) transceiver. Only blocks pertinent to the present invention are shown in the figure. Compared with the gigabit Ethernet of FIG. 2, the fast Ethernet uses a Medium Independent Interface (MII) block 20B instead of the GMII 20 in the gigabit Ethernet, and uses a joint decision feedback equalizer (DFE) and slicer 31B instead, of the joint DFE and TCM decoder 31 in the gigabit Ethernet. The echo canceller 29 and the NEXT canceller 30 of the gigabit Ethernet are not necessary in the fast Ethernet. It is noted that 1D symbols are defined in the fast Ethernet, compared with the 4D symbols used in the gigabit Ethernet.

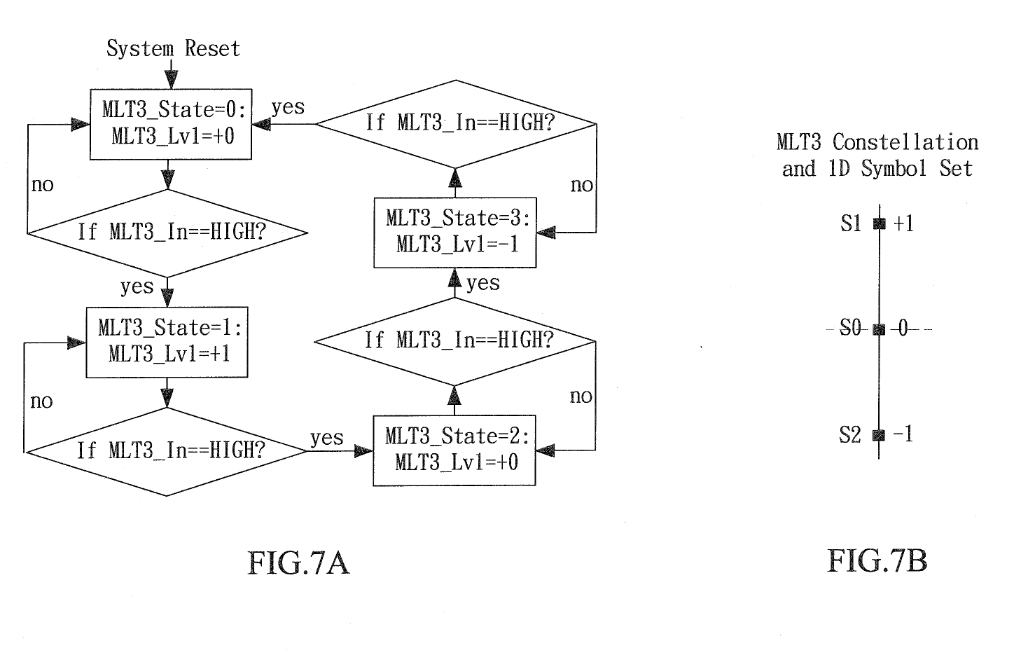

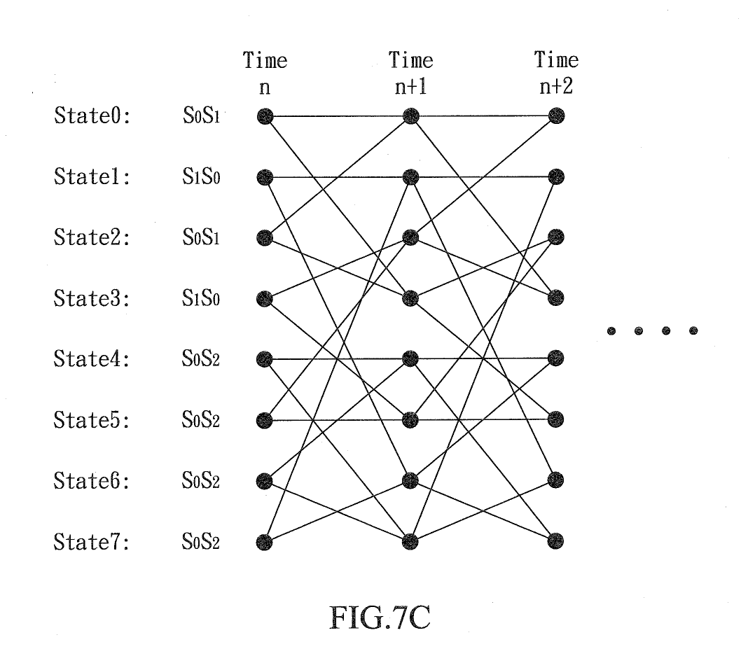

In the fast Ethernet, multi-level transmit-3 (MLT3) is used as a line code. FIG. 7A shows a flow diagram of an MLT3 encoder, by which the output (MLT3_Lv1) of the MLT3 encoder cycles through four states respectively corresponding to voltage levels “+0” (state 0), “+1” (state 1), “4-0” (state 2) and “−1.” (state 3). The level of the output (MLT3_Lv1) moves to the next state when the input (MLT3_In) becomes high (“1”), and stays in the same state when the input (MLT3_In) is low (“0”). FIG. 7B shows a ID symbol set for a three-level MLT3 constellation.

With respect to the MLT3, a trellis state transition similar to (but not the same as) that shown in FIG. 5 for Trellis code may be obtained, for example, by extending to two times the baud time. FIG. 7C shows exemplary trellis state transition of MLT3 with eight states. Compared to the trellis state transition shown in FIG. 5, it is observed, that two branches to a node in MLT3, while four branches lead to a node in Trellis code.

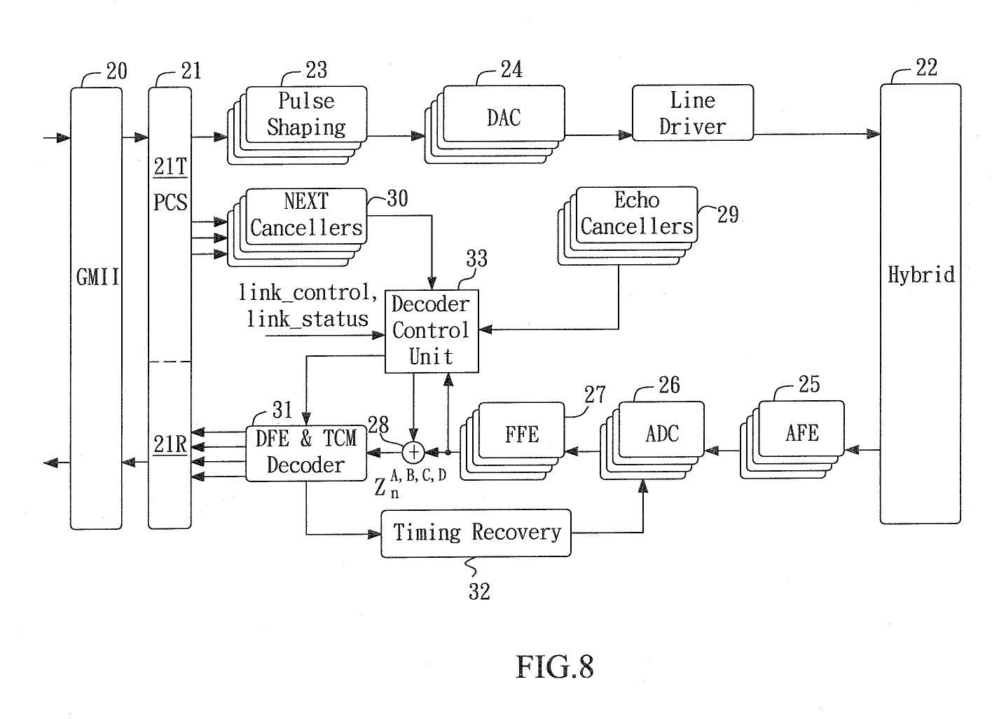

FIG. 8 shows a block diagram of an adaptive gigabit Ethernet transceiver according to a first embodiment of the present invention. Only blocks pertinent to the present invention are shown in the figure. Compared with the Ethernet transceiver of FIG. 2, the Ethernet transceiver of FIG. 8 further includes a decoder control unit 33 that may be used to adaptively block the echo quantity of echo cancellers 29 and the near-end crosstalk quantity of NEXT cancellers 30 from entering the summing device 28 in a non-gigabit mode. The decoder control unit 33 may also be used to adaptively turn off (or disable) a portion (while retain the remaining portion) of the joint DFE & TCM decoder 31 in the non-gigabit mode, thereby saving power consumption.

In the embodiment, the Ethernet transceiver may be operated in the following three modes: a gigabit mode, an enhanced 100M mode and a basic 100M mode. It is noted that the enhanced 100M mode and the basic 100M mode may be collectively called non-gigabit mode. Specifically speaking, in the gigabit mode, the transceiver operates at a link speed of 1000M hit/second. The decoder control unit 33 let the echo quantity of echo cancellers 29 and the near-end crosstalk quantity of NEXT cancellers 30 pass through and enter the summing device 28, and renders the joint DFE & TCM decoder 31 fully function. As a result, the Ethernet transceiver functions in a manner equivalent to the Ethernet transceiver as depicted in FIG. 2. In the enhanced 100M mode, the transceiver operates at a link speed of 100M bit/sec. The decoder control unit 33 blocks the echo quantity of echo cancellers 29 and the near-end crosstalk quantity of NEXT cancellers 30 from entering the summing device 28, and turns off (or disables) a portion of the joint DFE & TCM decoder 31. As a result, the Ethernet transceiver functions in a manner equivalent to the Ethernet transceiver as depicted in FIG. 6. In the basic 100M mode, the transceiver operates at a link speed of 100M bit/sec. The decoder control unit 33 blocks the echo quantity of echo cancellers 29 and the near-end crosstalk quantity of NEXT cancellers 30 from entering the summing device 28, and turns off (or disables) a portion of the joint DFE & TCM decoder 31 with an extent greater than that in the enhanced 100M mode. As a result, the Ethernet transceiver functions in a manner equivalent to the Ethernet transceiver as depicted in FIG. 6.

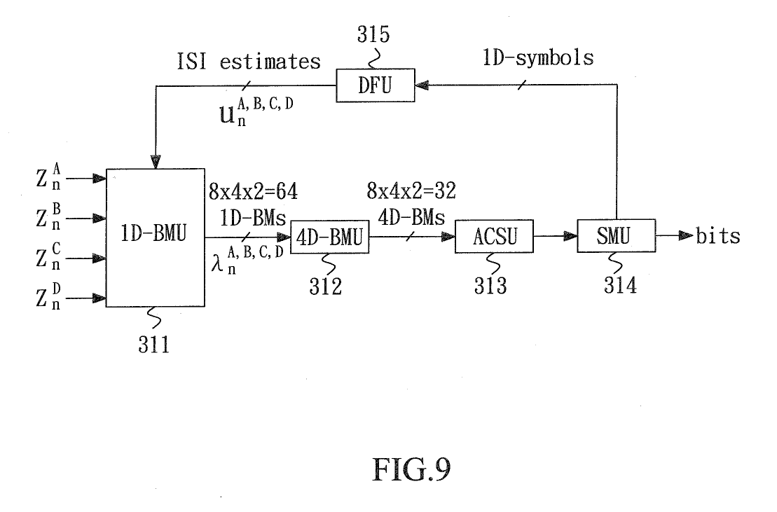

FIG. 9 shows a detailed block diagram of the joint DFE & TCM decoder 31 (FIG. 8), according to one embodiment of the present invention, which includes a 1D branch metric unit (1D-BMU) 311, a 4D branch metric unit (4D-BMU) 312, an add-compare-select unit (ACSU) 313, a survivor memory unit (SMU) 314 and a decision feedback unit (DFU) 315. Among the blocks shown in FIG. 9, the 1D-BMU 311, the 4D-BMU 312, the ACSU 313 and the SMU 314 collectively form the TCM decoder, which then joints the DFU 315. Specifically, the 1D-BMU 311 calculates 1D branch metrics λₙ^{A,B,C,D}, and the 4D-BMU 312 combines the 1D branch metrics (1D-BMs) from the ID-BMU 311 to generate 4D branch metrics (4D-BMs). Subsequently, the ACSU 313 performs ACS operation on the 4D-BMs, for each code state, to obtain path metrics. According to one aspect of the present invention, the SMU 314 of the present embodiment stores to keep track of symbols, rather than storing surviving state transition to record path history as in conventional counterpart. The DFU 315 of the present embodiment is coupled to receive the 1D symbols directly from the SMU 314 in order to estimate ISI quantity uₙ^{A,B,C,D}, which is then fed back to the 1D-BMU 311 to assist in 1D-BMs calculation. The details of the blocks of FIG. 9 are described in the following paragraphs. It is particularly noted that, in the non-gigabit mode, the 1D branch metrics (1D-BMs) from the 1D-BMU 311 may bypass the 4D-BMU 312 and go directly to the ACSU 313, for the rationale that only 1D symbols are defined in the non-gigabit mode. Accordingly, the 4D-BMU 312 may thus be turned off (or disabled) in the non-gigabit mode to reduce power consumption.

In the embodiment, the 1D branch metrics (ID-BMs) λₙ^{A,B,C,D}, corresponding to code state ρₙ and wire pair (or channel) j (j=A, B. C or D) at time n may be calculated in the 1D-BMU 311 according to

λₙ^{j}(zₙ^{j},aₙ^{j},ρₙ)=(zₙ^{j}−aₙ^{j}+uₙ^{j}(ρₙ))².

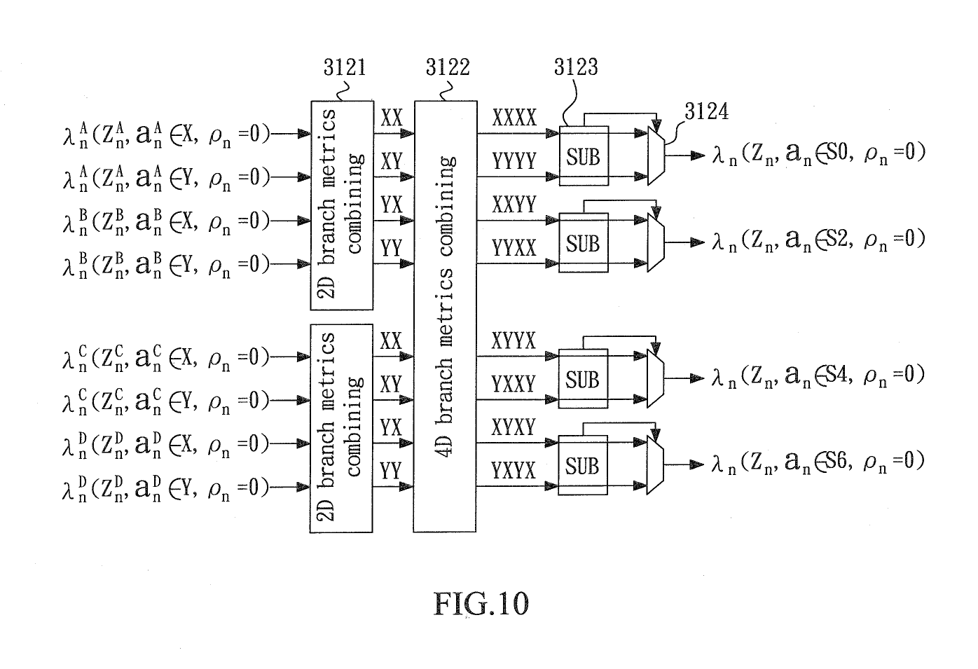

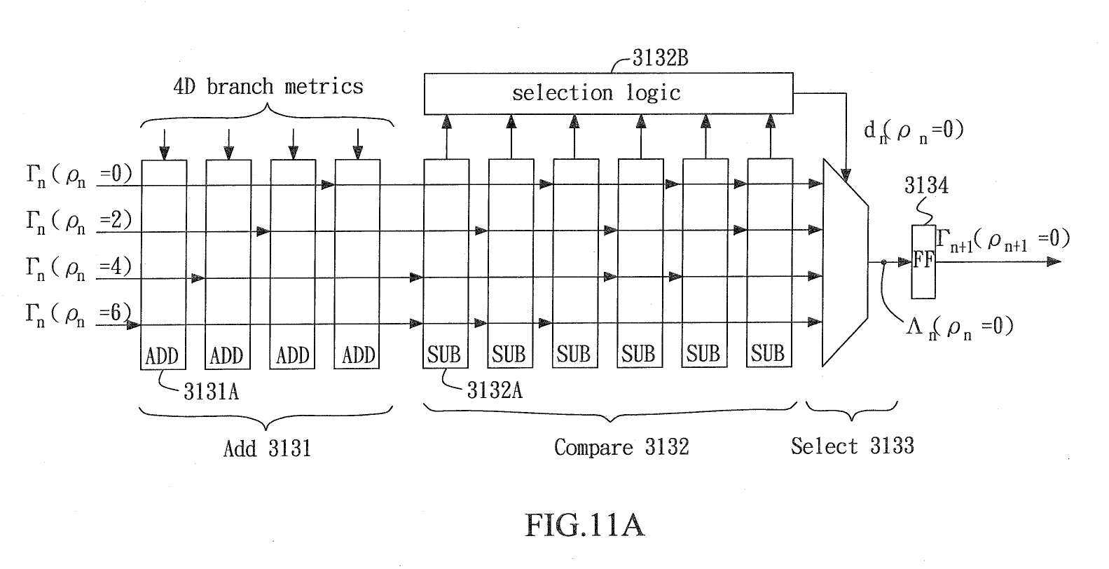

FIG. 10 shows a detailed block diagram exemplifying the 4D-BMU 312 for calculating 4D branch metrics (4D-BMs) from state 0. The 1D branch metrics (1D-BMs) are first combined by 2D-BM combining block 3121 to form 2D branch metrics, followed by being combined, to form 4D branch metrics by a 4D-BM combining block 3122. The complementary 4D branch metrics (e.g., XXYY and YYXX) are then compared by a comparator 3123, which may be preferably implemented by a subtracting device (SUB). The 4D branch metric with least value will be selected by a selecting device 3124, which may be preferably implemented by a multiplexer. As mentioned above, the 4D-BMU 312 may be bypassed in the non-gigabit mode.

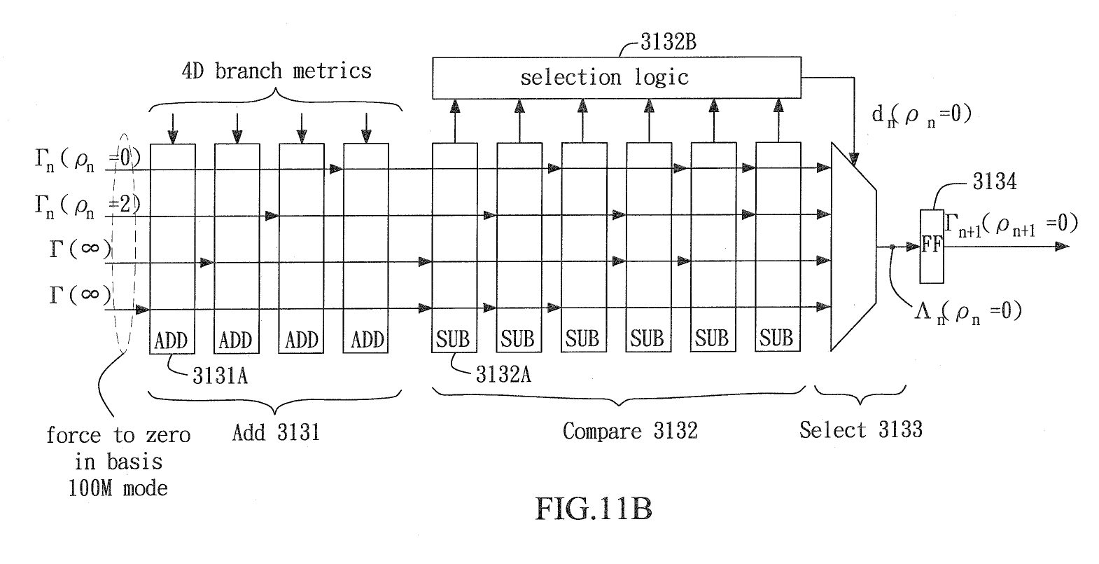

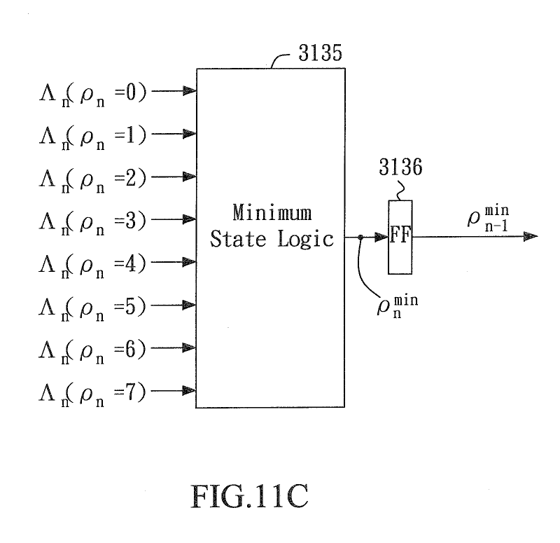

FIG. 11A shows a detailed block diagram exemplifying the ACSU 313 for updating the path metrics for state 0. The ACSU 313 generally includes an add portion 3131, a compare portion 3132 and a select portion 3133. Specifically, the add portion 3131 adds the 4D branch metrics to the current path metrics ┌ₙ by adders 3131A respectively. Subsequently, the outputs of the add portion 3131 are compared, e.g., two by two, by comparators 3132A such as subtracting devices (SUBs). The comparison results are processed by a selection logic 31321B to result in a decision value dₙ, which selects the output Λₙ of the add portion 3131 with least value. An updated path metric┌ₙ₊₁ may then be obtained from a flip-flop (FF) 3134 that is coupled to receive the output Λₙ of the add portion 3131 with least value.

As mentioned above, for the fact that fewer branches are involved in the MLT3 trellis state transition (FIG. 7C) than the Trellis code state transition (FIG. 5) in the gigabit mode, some path metrics ┌ₙ corresponding to uninvolved, states may be ignored by tying those uninvolved (invalid) path metrics ┌ₙ with a great value (denoted by ∞) that is substantially greater than other valid path metrics ┌ₙ. FIG. 11B shows a detailed block diagram exemplifying the ACSU 313 for updating the path metrics for state 0 in the non-gigabit mode.

As shown in FIG. 11C, the ACSU 313 of the present embodiment may further include a minimum state logic 3135 that outputs the state ρₙ with least value of the output Λₙ of the select portion 3133, thereby resulting in a minimum, state ρₙ^{min} at time n. A minimum state ρₙ₋₁^{min} at time n−1 may be obtained from a flip-flop (FF) 3136 that is coupled to receive the minimum state ρₙ^{min} at time n. It is particularly noted that the output (i.e., ρₙ^{min}) of the minimum state logic 3135 may be forced to “0” in the basic 100M mode to reduce power consumption.

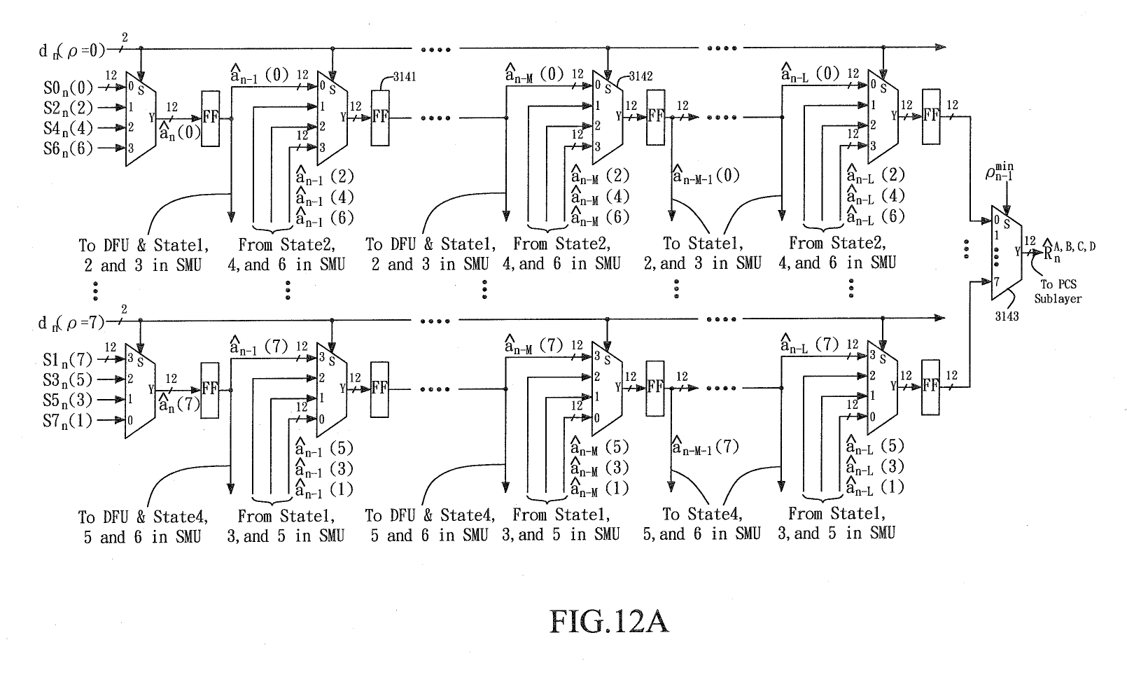

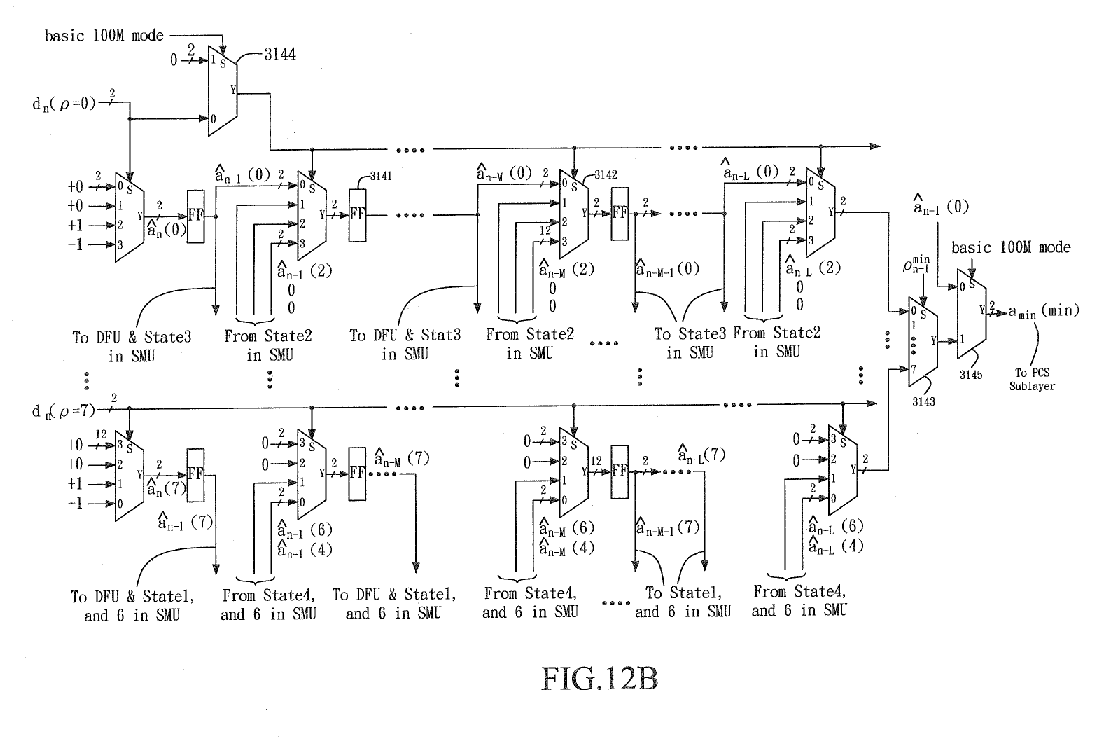

FIG. 12A shows a detailed, block diagram of the SMU 314 (FIG. 9) in the gigabit mode according to one embodiment of the present invention. In the embodiment, the SMU 314 includes a number of chains, each of which corresponds to a distinct state ρ. In the embodiment, each chain includes a series of L flip-flops (FFs) 3141 that are used to store symbols â in a chronological order. Selecting devices 3142 such as multiplexers are respectively interspersed between the adjacent FFs 3141 to select the symbol a according to the decision value dₙ of the selection logic 3132B in the ACSU 313 (FIG. 11A). As a result, a history or chronicle of preceding symbols may be stored in the SMU 314. According to one aspect of the present invention, the present embodiment further includes a selecting device 3143 such as a multiplexer that selects the output symbol from the chain that corresponds to the minimum state ρₙ₋₁^{min} at time n−1 (FIG. 11C). Accordingly, the reliability of the entire transceiver may be further increased. The 12-bit output aₘᵢₙ of the selecting device 3143 is de-mapped to 9-bit data before being fed to the PCS block 21 (FIG. 8).

FIG. 12B shows a detailed block diagram of the SMU 314 (FIG. 9) in the non-gigabit mode according to one embodiment of the present invention. It is noted that, in the basic 100M mode, a selecting device 3144 (such as a multiplexer) is further used to select “0” instead of the decision value dₙ for providing to the selecting devices 3142. Moreover, in the basic 100M mode, a selecting device 3145 (such as a multiplexer) is further used to tie the current symbol âₙ₋₁(0) as the output aₘᵢₙ.

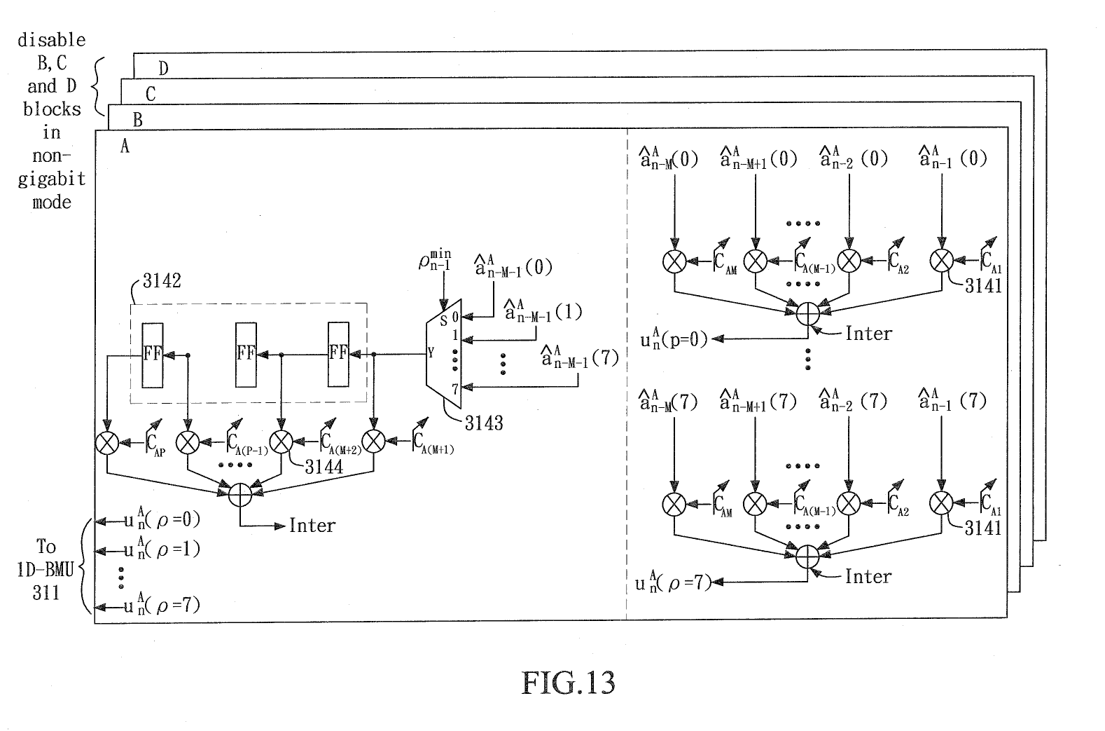

FIG. 13 shows a detailed block diagram of the DFU 35 (FIG. 9) according to one embodiment of the present invention. Specifically, for each dimension A, B, C or D, the DFU 35 includes eight first filters for eight Trellis states ρ(=0 to 7) respectively, as shown on the right-hand side of the figure. Each first filter is coupled to receive symbols â^{A,B,C,D} from the SMU 314 (FIG. 9). The symbols â^{A,B,C,D} are then multiplied by coefficients C_{A1}, C_{A2} to C_{AM}, e.g., by multipliers 3141 respectively. The multiplied symbols are then summed up with an intermediate value (Inter) that is generated from a second filter as shown on the left-hand side of the same figure. The output, i.e., the estimated. ISI quantity uₙ^{A,B,C,D}, of the first filters is then fed back to the 1D-BMU 311 (FIG. 9). The second filter, for each dimension A, B, C or D, includes a shift register 3142 made of a series of flip-flops (FFs) 3142A that is coupled to receive a symbol â^{A,B,C,D} from the SMU 314, e.g., by a multiplexer 3143 according to the minimum, state ρₙ₋₁^{min} at time n−1. The symbols outputted from the shift register 3142 are multiplied by coefficients C_{A(M+1)}, C_{A(M+2)} to C_{AP}, e.g., by multipliers 3144 respectively. The multiplied symbols are then summed up to generate the intermediate value (Inter). It is particularly noted that, in the non-gigabit mode, the DFU 35 corresponding to dimensions B, C and D may be disabled (or turned, off) to reduce power consumption.

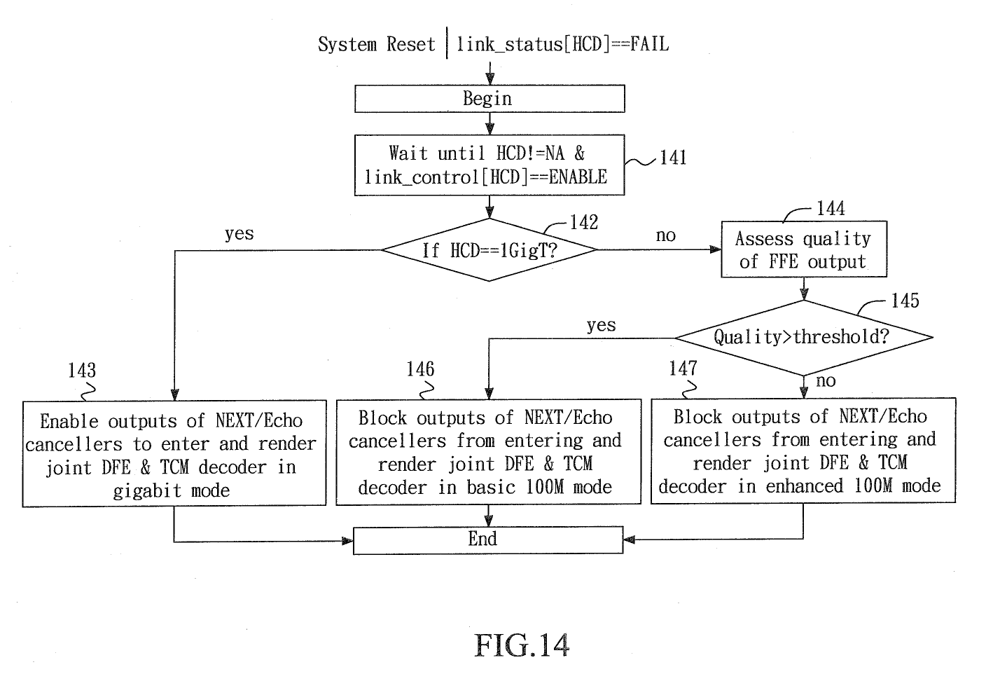

FIG. 14 shows a flow diagram of the decoder control unit 33 of FIG. 8 according to one embodiment of the present invention. In step 141, the flow waits until the highest common denominator (HCD) indicating the greatest common link speed between two transceivers is available and link_control parameter is “ENABLE” indicating that auto-negotiation turns control over to the PRY for data processing. In step 142, if it is determined that HCD indicates link speed of 1000M bit/sec, the decoder control unit 33 enables the outputs of the NEXT/Echo cancellers 30/29 to enter the summing device 28, and renders the joint DFE & TCM decoder 31 in the gigabit mode (step 143). If it is determined in step 142 that HCD indicates link speed of 100M bit/see, the output of the FFE 27 is assessed for a predetermined period, for example, taking into consideration its quality such as the signal-to-noise ratio (SNR) (step 144). Subsequently, in step 145, if the FFE output has a quality greater than a predetermined threshold, the decoder control unit 33 blocks the outputs of the NEXT/Echo cancellers 30/29 from entering the summing device 28, and renders the joint DFE & TCM decoder 31 in the basic 100M mode (step 146). Otherwise, in step 147, the decoder control unit 33 blocks the outputs of the NEXT/Echo cancellers 30/29 from entering the summing device 28, and renders the joint DFE & TCM decoder 31 in the enhanced 100M mode.

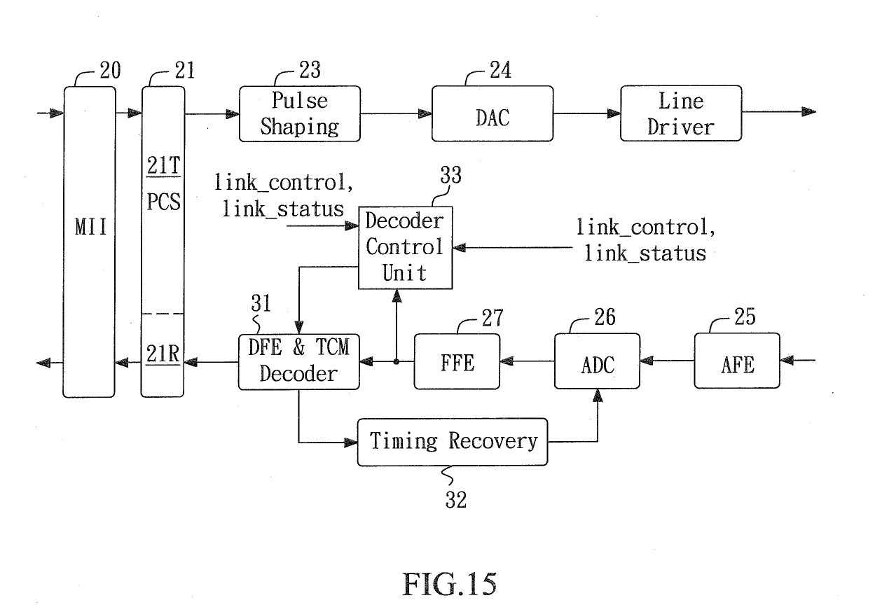

FIG. 15 shows a block diagram of an adaptive fast Ethernet transceiver according to a second embodiment of the present invention. Compared to the transceiver of the first embodiment (FIG. 8), the NEXT/Echo cancellers 30/29 and the summing device 28 are not necessary in the transceiver of the present embodiment. As the transceiver of the present embodiment is a fast Ethernet only transceiver, it may be operated in the following two modes: an enhanced 100M mode and a basic 100M mode.

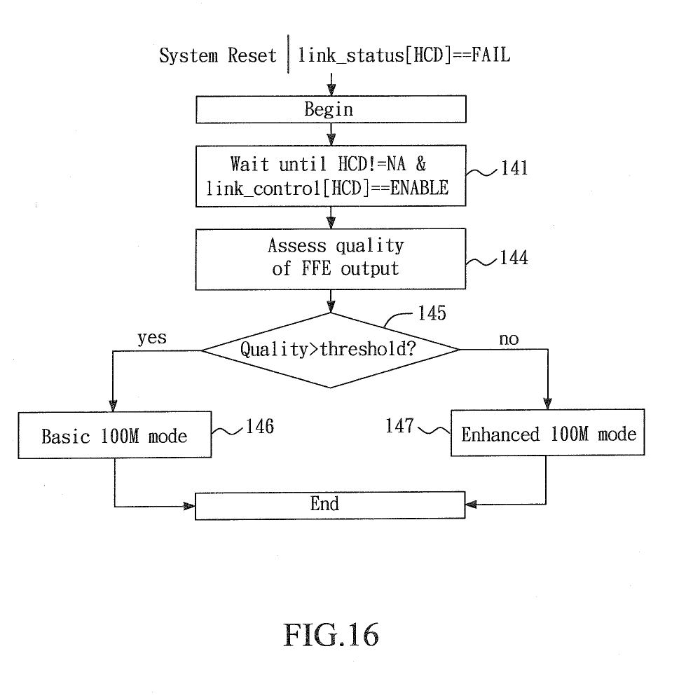

FIG. 16 shows a flow diagram of the decoder control unit 33 of FIG. 15 according to one embodiment of the present invention. In step 141, the flow waits until the highest common denominator (HCD) indicating the greatest common link speed between two transceivers is available and link_control parameter is “ENABLE” indicating that auto-negotiation turns control over to the PHY for data processing. In step 144, the output of the FFE 27 is assessed for a predetermined period, for example, taking into consideration its quality such as the signal-to-noise ratio (SNR). Subsequently, in step 145, if the FFE output has a quality greater than a predetermined threshold, the decoder control unit 33 renders the joint. DFE & TCM decoder 31 in the basic 100M mode (step 146). Otherwise, in step 147, the decoder control unit 33 renders the joint DFE & TCM decoder 31 in the enhanced 100M mode.

Although specific embodiments have been illustrated and described, it will be appreciated by those skilled in the art that various modifications may be made without departing from the scope of the present invention, which is intended to be limited solely by the appended claims.

What is claimed is:

1. An adaptive Ethernet transceiver, comprising:
a joint decision feedback equalizer (DFE) and Trellis decoder configured to decode a receiving signal; and
a decoder control unit configured to adaptively disable a portion of the joint DFE and Trellis decoder in a non-specified link speed mode.

2. The adaptive Ethernet transceiver of claim 1, further comprising at least one canceller configured to cancel echo or crosstalk.

3. The adaptive Ethernet transceiver of claim 2, wherein the decoder control unit adaptively blocks an output of the canceller from entering the joint DFE and Trellis decoder in the non-specified link speed mode.

4. The adaptive Ethernet transceiver of claim 2, wherein the at least one canceller is an echo canceller or a near-end crosstalk canceller.

5. The adaptive Ethernet transceiver of claim 2, further comprising a summing device configured to adaptively subtract an output of the canceller from the receiving signal, thereby resulting in a cancelled signal that is then fed to the joint DFE and Trellis decoder.

6. The adaptive Ethernet transceiver of claim 1, wherein the Ethernet transceiver is compliant with 1000BASE-T, and the non-specified link speed mode adopts a link speed slower than gigabit per second.

7. The adaptive Ethernet transceiver of claim 6, wherein the non-specified link speed mode adopts the link speed of 100M bit per second, and the available non-specified link speed modes comprise a basic 100M mode and an enhanced 100M mode, wherein the portion of the joint DFE and Trellis decoder is disabled in the basic 100M mode with an extent greater than in the enhanced 100M mode.

8. The adaptive Ethernet transceiver of claim 7, wherein the receiving signal is assessed, resulting an assessed result, based on which the basic 100M mode or the enhanced 100M mode determined.

9. The adaptive Ethernet transceiver of claim 8, wherein a signal-to-noise ratio of the receiving signal is assessed.

10. The adaptive Ethernet transceiver of claim 7, wherein, the joint DFE and Trellis decoder comprises:
a Trellis coded modulation (TCM) decoder including:
a one-dimensional branch metric unit (1D-BMU) configured to calculate 1D branch metrics;
a four-dimensional branch metric unit (4D-BMU) configured to combine the 1D branch metrics to generate 4D branch metrics;
an add-compare-select unit (ACSU) configured to perform add, compare and select (ACS) operations on the 4D branch metrics for each state to obtain path metrics;
a survivor memory unit (SMU) configured to store and keep track of symbols; and
a decision feedback unit (DFU) coupled to receive the symbols from the SMU in order to estimate inter-symbol interference (ISI) quantity, which is then fed back to the 1D-BMU.

11. The adaptive Ethernet transceiver of claim 10, wherein the ACSU comprises:
an add portion configured to add the 4D branch metrics to current path metrics;
a compare portion configured to compare outputs of the add portion, thereby resulting in a decision value; and
a select portion configured to select the least-value output of the add portion according to the decision value;
wherein the current path metrics corresponding to invalid states in the non-specified link speed mode are tied with a value that is substantially greater than the value of the current path metrics corresponding to valid states.

12. The adaptive Ethernet transceiver of claim 11, wherein the ACSU further comprises a minimum state logic configured to output a minimum state corresponding to the least-value output of the select portion, wherein the outputted minimum state is forced to “0” in the basic 100M mode.

13. The adaptive Ethernet transceiver of claim 10, wherein the DFU corresponding to invalid, dimension in the non-specified link speed mode is disabled by the decoder control unit.
